(19) United States
(12) Patent Application Publication
(10) Pub. No.: US 2004/0194264 A1
(43) Pub. Date: Oct. 7, 2004

(54) Release device

(76) Inventor: Malte Johansson, (US)

Correspondence Address: YOUNG & THOMPSON, 745 SOUTH 23RD STREET 2ND FLOOR, ARLINGTON, VA, 22202

(21) Appl. No.: 10/492,426

(22) PCT Filed: Oct. 10, 2002
(86) PCT No.: PCT/SE02/01845

(30) Foreign Application Priority Data
Oct. 12, 2001 (SE) 0103393-5

(51) Int. Cl. A44B 11/26; B60R 22/34

(52) U.S. Cl. 24/602

(57) ABSTRACT

The present invention relates to a release device, especially in relation to a buckle of a safety helmet or a safety belt. It is significant of the release device according to the present invention that the device comprises a first element (1) and a second element (3) that are pivotally connected to each other via a hinge (9), means (10) of one element (1) to connect one end of the strap/belt, a yieldable release means (14) and an anchoring element (17) connected to the other end of the strap/belt, that the anchoring element (17) is connected in a releasable way to the elements (1, 3), and that a force (F1) is applied to the release means (14) when the anchoring element (17) is subjected to force (F2) that strives to separate the anchoring element (17) from the elements (1, 3).

### TECHNICAL FIELD OF THE INVENTION

The present invention relates to a release device, especially in relation to a buckle of a safety helmet or a safety belt.

### PRIOR ART

From U.S. Pat. No. 4,815,177 a buckle of a safety belt is previously known, said buckle will open after a certain time delay in connection with a collision. In connection therewith a spring must initially be released, this being effected by applying an exceptional force to the belt, e.g. in connection with a collision. Thereafter, a yoke, included in the buckle, will be urged downwards by two main springs and the yoke affects levers that effects release of the belt at one side of the buckle. In order to prevent that this is not happening too fast the movement of the yoke is counteracted by a time delay unit that includes pressurised bellows. There is no doubt that the buckle according to U.S. Pat. No. 4,815,177 is structurally extremely complicated and hence also expensive to manufacture. By having a number of components to cooperate there is also a risk of disturbances in operation.

From WO 90/09909 a buckle of a safety belt is previously known, said buckle will open after certain time delay in connection with a collision. Also this buckle is structurally extremely complicated and due to its complicated structure it is also relatively seen voluminous. The user is to determine whether the automatic release is to be activated or not.

### OBJECTS AND FEATURES OF THE INVENTION

A primary object of the present invention is to disclose a release device of the type defined above, said device being structurally extremely simple.

A further object of the present invention is that the release device should be inexpensive to manufacture due to its simple structural design.

Still an object of the present invention is to give the release device a compact design, especially as regards the automatic release function.

At least the primary object of the present invention is realised by means of a release device that has been given the features of the appending independent claim 1.

### BRIEF DESCRIPTION OF THE DRAWINGS

Below an embodiment of the invention will be described, reference being made to the accompanying drawings, where:

FIG. 1 shows a schematic side view of a release device according to the present invention, said release device being in inactivated position;

FIG. 2 shows a detail, partly sectioned, of the release means of the release device according to FIG. 1; and

FIG. 3 shows the release device when the release means is activated.

### DETAILED DESCRIPTION OF A PREFERRED EMBODIMENT OF THE INVENTION

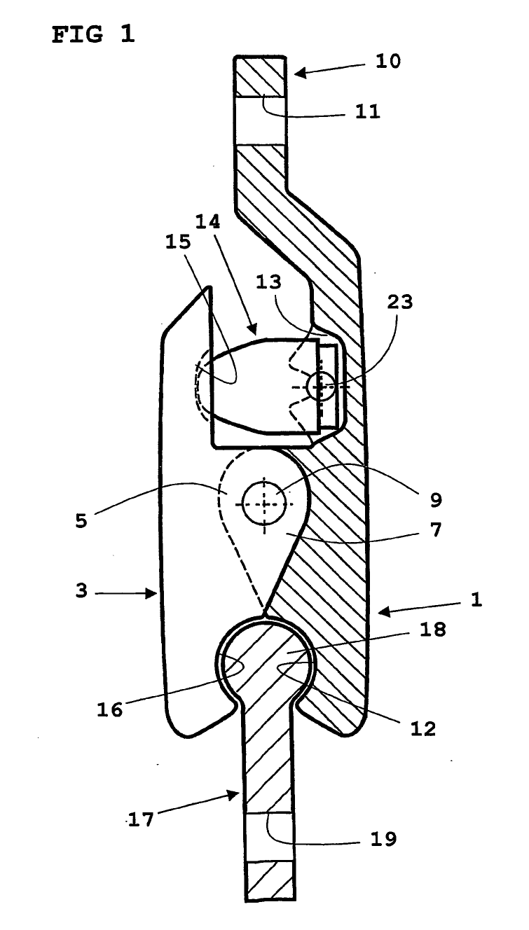

The release device shown in FIG. 1 comprises a first element 1 and a second element 3, each of said elements 1, 3 being equipped with an eye 5 and 7 respectively, said eyes 5, 7 being mutually connected by means of a hinge 9. This means that the elements 1 and 3 are hingedly connected to each other, i.e. the elements may pivot relative to each other around said hinge 9.

The first element 1 has generally an elongated shape and has at one end a first attachment portion 10 that is equipped with a first hole 11 for anchoring of one end of a strap/belt (not shown). In the area of its other end the first element 1 has a first recess 12 that in the shown embodiment has a curved shape. In an intermediate portion the first element 1 has a first depression 13 that in the shown embodiment constitutes a seat of a release means 14 that constitutes a portion of the release device according to the present invention, said release means 14 being fixed in the depression 13. The release means 14 will be described more in detail below.

In the shown embodiment the second element 3 is shorter than the first element 1. In the area of the upper end of the second element 3 in FIG. 1 a second depression 15 is provided, said second depression 15 being located directly opposite the first depression 13 and facing said first depression 13. As is evident from FIG. 1 the free end of the release means 14 is received in the second depression 15. In the area of the lower end of the second element 3 in FIG. 1 a second recess 16 is provided, said second recess 16 having a corresponding shape as the first recess 12, being located directly opposite said first recess 12 and facing said first recess 12. In the view shown in FIG. 1 the first and second recesses 12, 16 together form a circular recess.

In the release device according to the present invention an anchoring element 17 is also included, by which a free end of a strap/belt (not shown) may be anchored in the recesses 12, 16. The anchoring element 17 has a bulge 18 at one end, said bulge 18 being intended to be received in the recesses 12, 16, see FIG. 1, the bulge 18 suitably having a shape that corresponds to the shape that the recesses 12, 16 together define. In the area of its other end the anchoring element 17 has a second hole 19, in which an end of a strap/belt (not shown) may be anchored.

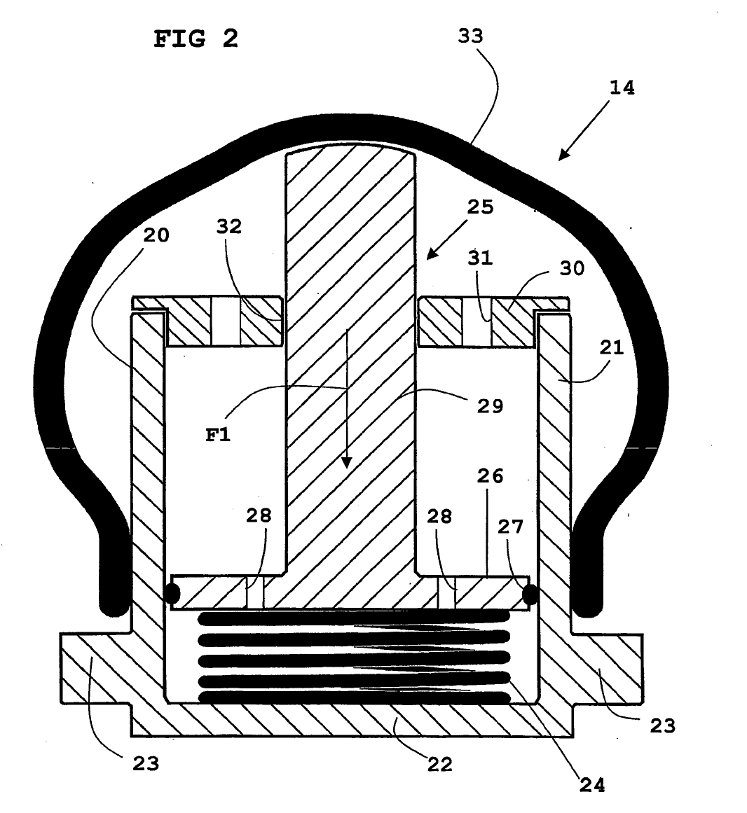

The release means 14, shown in detail in FIG. 2, comprises a cylinder 20 that has a cylinder wall 21 and a bottom portion 22. In the transition between the cylinder wall 21 and the bottom portion 22 two diametrically located spigots 23 are provided, by which the release means 14 is mounted tiltable in the first depression 13. In the cylinder 20 a pressure spring 24 is received; said pressure spring 24 resting against the bottom portion 22 of the cylinder 20. On top of the pressure spring 24 a piston 25 is arranged and a pressure plate 26 of the piston 25 is sealed against the cylinder wall by means of a sealing in the shape of an O-ring 27. The pressure plate 26 has two through-going third holes 28. The piston 25 has also a shaft 29 that is integral with the pressure plate 26 and has an extension perpendicular to the pressure plate 26 on the side facing away from the pressure spring 24.

At the open end of the cylinder 20 a guide washer 30 is provided, said guide washer 30 being fixedly attached to the open end of the cylinder 20 preferably by means of a thread connection (not shown) between the guide washer 30 and the inner side of the cylinder wall 21. The guide washer 30 has two fourth holes 31 and the central opening 32, through which the shaft 29 passes.

The release means also comprises a casing in the shape of a sealing gaiter 33 that is sealingly connected to the outer side of the cylinder wall 21. The sealing gaiter 33 surrounds the cylinder wall 21, the shaft 29 and the guide washer 30. The sealing gaiter 33 is manufactured from a flexible material, e.g. rubber or plastic.

A principally incompressible pressure medium, preferably a liquid, is enclosed inside the sealing gaiter 33 and this pressure medium also fills out the inner of the cylinder 20, i.e. said pressure medium is present both below and above the pressure plate 26.

The release means 14 of the release device according to the present invention functions in the following way, reference being made to FIG. 2 where the release means 14 is located in an intermediate position, and i.e. the pressure plate 26 has been displaced a certain distance in direction towards the bottom 22 of the cylinder 20.

When a force F1 that is directed towards the pressure plate 26 is applied to the shaft 29 the pressure spring 24 will counteract said force F1. By choosing a pressure spring 24 having a certain spring stiffness the release device may be dimensioned for a certain opening force, i.e. the force required to effect release of the release device. It is now assumed that the force Fl that actuates the shaft 29 is sufficiently large to compress the pressure spring 24. In connection therewith the pressure medium that is present between the bottom 22 and the pressure plate 26 will be squeezed out through the third holes 28 that function as restrictions, i.e. the displacement of the pressure plate 26 in direction towards the bottom 22 will be effected at a certain time delay depending on the number of third holes 28 and their size. By choosing said parameters the time delay of the displacement of the pressure plate 26 is determined. When the pressure plate 26 is displaced in direction towards the bottom 22 a major part of the shaft will be located inside the cylinder 20, i.e. in the space defined by the cylinder wall 21, the pressure plate 26 and the guide washer 30. This means that the volume of this space continuously is decreasing since a major part of the shaft 29 is pushed into said space. A portion of the pressure medium that is located in the space therefore must be discharged and this being effected through the fourth holes 31, i.e. the discharged pressure medium will enter the space between the outer side of the cylinder 20 and the sealing gaiter 33. Since the sealing gaiter 33 is of a flexible material the discharged pressure medium may be received in the space between the cylinder 20 and the sealing gaiter 33 due to the fact that the sealing gaiter 33 expands. When the force Fl that affects the shaft 29 ceases the release means 14 will return to its initial position since the pressure spring 24 displaces the pressure plate 26, with its adherent shaft 29, in direction from the bottom 22. The pressure medium will then flow back through the holes 28 and 31, in opposite direction compared to what has been described above in connection with the displacement of the pressure plate 26 in direction towards the bottom 22.

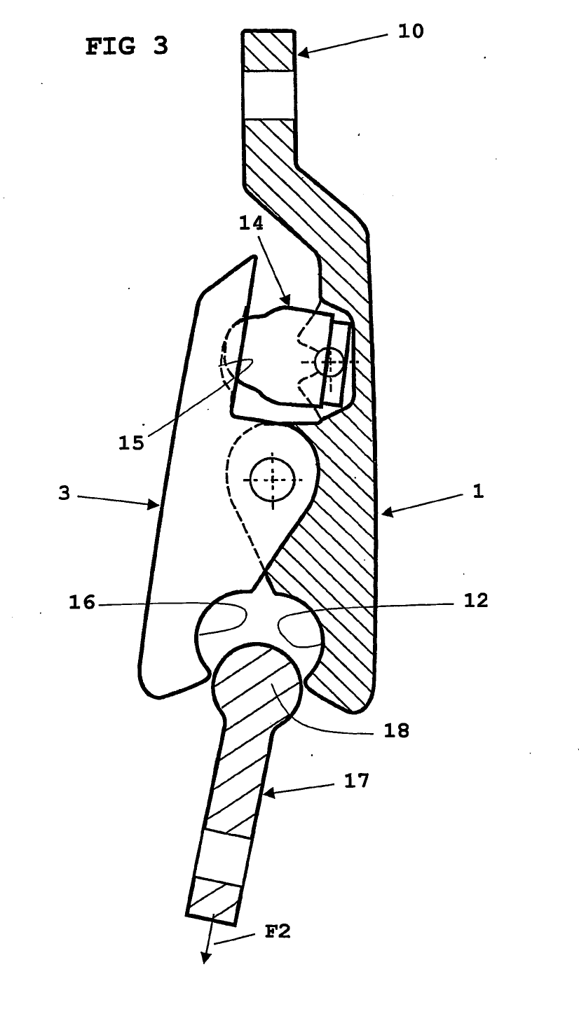

The force F1 that affects the shaft according to FIG. 2 is normally provided by pivoting the first and second elements 1 and 3 relative to each other, see FIG. 3. In connection therewith the second depression 15 of the second element 3 will generate the force Fl when the elements 1 and 3 are pivoted relative to each other in the way that is shown in FIG. 3. In connection with the displacement of the second depression 15 in direction towards the first depression 13 the release means 14 will tilt, see FIG. 3, which minimises the mutual displacement between the sealing gaiter 33 and the second depression 15. This guarantees that the force Fl on the shaft 29 of the release means 14 will act in the longitudinal direction of the shaft 29.

By studying FIG. 3 it is realised that the pivoting of the elements 1 and 3 relative to each other around the hinge 9 is effected by a second force F2 that acts on the anchoring element 17 in a direction away from the bulge 18 of the anchoring element 17. This force F2 is created when the strap/belt that is connected to the release device according to the present invention is subjected to a stress, e.g. if the carrier of a bicycle helmet is jammed with the helmet itself in a too narrow opening or the belt of the helmet is hitched to a rigid object, e.g. a hook or the like. The force F2 will then, via the bulge 18, affect the elements 1 and 3 with an expanding force that strives to draw the recesses 12 and 16 away from each other. When the drawing away of the elements 1 and 3 has reached a certain limit the recesses 12 and 16 will not be able to hold be bulge 18 but the bulge 18 will be released from the elements 1 and 3, this being illustrated in FIG. 3. Thereby, the release device has completed its function, i.e. one end of the strap/belt is released.

In order to reset the release device to its initial position a force Fl, preferably effected manually, is again applied to the release means 14 to draw the recesses 12 and 16 away from each other and then the bulge 18 may be positioned in the space between the recesses 12 and 16. As soon as the force F1, applied to the release means 14, ceases the pressure spring 24 will return the elements 1 and 3 to their initial position, see FIG. 1.

If the strap/belt that the release device according to the present invention is connected to is subjected to a momentary jerk the release device will not release the anchoring element 17. The reason therefore is that both the pressure spring 24 and the pressure medium between the bottom 22 and the pressure plate 26 strive to counteract the motion of the pressure plate 26 that is initiated by a jerk. In order to effect a displacement downwards in FIG. 2 of the pressure plate 26 a permanent force must be applied to the strap/belt to initiate a displacement downwards of the pressure plate, i.e. pressure medium must pass through the third holes 28.

### Feasible Modifications of the Invention

In connection with the embodiment described above two third holes 28 are provided in the pressure plate 26. Within the scope of the present invention the number of holes and their size may vary in order to achieve a desired time delay in connection with release of the release device.

A further feasible alternative embodiment is to delete the sealing 27 and the third holes 28. The pressure medium will then bypass the pressure plate 26 via a leakage flow between the circumference of the pressure plate 26 and the cylinder wall 21.

1. Release device of a strap/belt, especially in relation to a buckle of a safety helmet or a safety belt, the device comprising a first element (1) and a second element (3) that are pivotally connected to each other via a hinge (9), means (10) of one element (1) to connect one end of the strap/belt, a yieldable release means (14) and an anchoring element (17) connected to the other end of the strap/belt, that the anchoring element (17) is connected in a releasable way to the elements (1, 3), and that a force (Fl) is applied to the release means (14) when the anchoring element (17) is subjected to a force (F2) that strives to separate the anchoring element (17) from the elements (1, 3), the release means (14) comprising a cylinder (20) having a piston (25), and means (24) to return the piston (25) to an initial position, characterized in that the release means (14) is directly affected by one of the elements (3) when the elements (1, 3) are pivoting relative to each other, that the release means (14) also comprises a casing (33) of a flexible material that surrounds the cylinder (20) and a pressure medium present inside the casing (33), said pressure medium being essentially incompressible.

2. Release device according to claim 1, characterized in that the release means (14) is provided in a space between the elements (1, 3).

3. Release device according to claim 2, characterized in that the piston (25) of the cylinder (20) comprises a pressure plate (26), and that a passage (28) is provided in order to allow pressure medium to bypass the pressure plate (26).

4. Release device according to claim 3, characterized in that means (27) is provided to seal the pressure plate (26) against the cylinder (20), and that the pressure plate (26) is equipped with at least one through-going hole (28).

5. Release device according to claim 2, characterized in that the means to return the piston (25) to initial position constitutes a pressure spring (24).

6. Release device according to claim 2, characterized in that a guide washer (30) is provided at the open end of the cylinder (20), that the guide washer (30) is equipped with a central opening (32) to receive a shaft (29) of the piston (25).

7. Release device according to claim 6, characterized in that the guide washer (30) is equipped with at least a fourth hole (31).

8. Release device according to claim 3 characterized in that the means to return the piston (25) to initial position constitutes a pressure spring (24).

9. Release device according to claim 4, characterized in that the means to return the piston (25) to initial position constitutes a pressure spring (24).

10. Release device according to claim 3, characterized in that a guide washer (30) is provided at the open end of the cylinder (20), that the guide washer (30) is equipped with a central opening (32) to receive a shaft (29) of the piston (25).

11. Release device according to claim 4, characterized in that a guide washer (30) is provided at the open end of the cylinder (20), that the guide washer (30) is equipped with a central opening (32) to receive a shaft (29) of the piston (25).

12. Release device according to claim 5, characterized in that a guide washer (30) is provided at the open end of the cylinder (20), that the guide washer (30) is equipped with a central opening (32) to receive a shaft (29) of the piston (25).
